(19) United States
(12) Patent Application Publication
(10) Pub. No.: US 2013/0337423 A1
(43) Pub. Date: Dec. 19, 2013

(54) METHOD FOR RELIEVING A PARTIAL AIRWAY OBSTRUCTION CAUSED BY A FOREIGN OBJECT

(71) Applicant: Brenda MALONEY, Cincinnati, OH (US)

(72) Inventor: Brenda MALONEY, Cincinnati, OH (US)

(21) Appl. No.: 13/524,097

(22) Filed: Jun. 15, 2012

(51) Int. Cl. G09B 19/00

(52) U.S. Cl. 434/262

(57) ABSTRACT

A method of breathing for a choking victim is disclosed, which allows the person to produce a forceful cough for relieving a partial upper airway obstruction caused by a foreign object. When a choking victim is able to move air and cough, the method of sitting or standing erect and inhaling air through the nose can be used to fill the lungs to the point where a powerful cough can be generated to relieve the obstruction. This posture allows inhalation of air through the nasopharynx in order to entrain a large volume of air into the lungs, and further allows the lungs to fully expand and the accessory expiratory muscle to better assist the diaphragm in forced expiration. In this manner, the victim can generate a cough having an expiratory force sufficient to dislodge a foreign object from the upper airway.

### FIELD OF THE INVENTION

The invention relates in general to upper airway obstructions caused by foreign objects, and in particular to a method for relieving a partial upper airway obstruction and/or preventing a complete upper airway obstruction caused by a foreign object.

### BACKGROUND OF THE INVENTION

The accident of a foreign object becoming lodged in the air passages is always of a serious and emergent nature. The object must be removed quickly, or else death from either inflammation/swelling of the airway or immediate suffocation may take place.

Choking is the mechanical obstruction of the flow of air into the lungs. Typically the trachea is closed off by the epiglottis during swallowing, but with an airway obstruction the epiglottis does not properly close off the trachea and a foreign object (consisting of either mucus from the lungs, or any object which comes from outside the body itself, including food, toys, coins or household objects) becomes either partially or completely lodged in the trachea. Choking is often suffered by small children, who are unable to appreciate the hazard inherent in putting small objects in their mouth. In adults, choking mostly occurs while eating.

Choking prevents breathing, and the obstruction to the upper airway can be partial or complete. With partial upper airway obstruction there is still some flow of air into the lungs, although inadequate, and breathing is labored and sometimes accompanied by gasping or wheezing. The victim has great difficulty and limited ability to speak or cry out, may exhibit violent and largely involuntary coughing, and will likely be very agitated. Once the obstruction becomes complete, the victim will not be able to move any air, and will no longer be able to speak or cry out. Coughing or other noises can no longer be made. If a complete upper airway obstruction is not relieved, the victim will not be able to get oxygen to the lungs, heart and brain, and will soon become cyanotic (i.e. turn blue) and unconscious. Prolonged, complete upper airway obstruction can lead to anoxia and death.

Known methods of treating choking include a number of different procedures, both basic (for first aid providers) and more advanced (for health professionals). In the United States, a large portion of the population has been taught that giving the victim abdominal thrusts, also known as the Heimlich maneuver, is the correct procedure for any person who is choking. This is largely due to widespread promotion of this technique in the past. However, abdominal thrusts are typically only performed on a person with a complete airway obstruction, i.e. one who is not able to move air and/or cannot speak or cry out. Due to the forceful nature of the procedure, bruising to the abdomen is highly likely and more serious injuries can occur, including fracture of the xiphoid process or ribs.

Back slaps, or the use of hard blows with the heel of the hand on the upper back of the victim, are intended to use percussion to create pressure behind the blockage, assisting the patient in dislodging the foreign object. The recommended number of back slaps to be used varies by training organization, but is usually between five and twenty. While often criticized for having the potential to lodge the foreign object further into the airway, in some cases the physical vibration of the action has been enough to cause movement of the foreign object sufficiently to allow clearance of the airway.

Encouraging the victim to cough has been promoted because it was found that many bystanders were too quick to perform potentially harmful interventions for obstructions which could have been dislodged without their participation. However, attempting to cough while choking usually involves a reflexive action of quickly and forcefully inhaling through the mouth prior to attempting to force air out of the lungs. This initial forceful inward movement of air through the mouth can cause the foreign object to become lodged further down into the trachea, thereby causing a complete obstruction. In addition, inhaling through the mouth typically does not provide enough air to fully expand the lungs, such that the choking victim may not be able to produce a forceful enough cough to expel the object.

Other known means for treating a choking victim include inversion (turning the choking victim upside-down), doing a “finger sweep” of the victim's mouth (typically only if the victim is unconscious, and only if the obstruction can be removed easily and without pushing it further down into the airway), and cricothyrotomy or other surgical incision into the neck, which require medical training and should only be performed as a final emergency maneuver.

While the above prior means for treating choking victims may be beneficial, they can also be harmful. It is therefore an objective of the present invention to provide a simple, non-dangerous means of relieving a partial airway obstruction. It is also an objective to provide a procedure for treating a choking victim who can still move air in and out and produce a cough. It would also be beneficial to provide a means for relieving a partial airway obstruction by promoting a suitable breathing technique for a choking victim to create a forceful cough.

### SUMMARY OF THE INVENTION

The present invention is a breathing method for a choking person to dislodge a foreign object causing a partial airway obstruction. The method is performed by sitting or standing up straight and sniffing, or inhaling through the nose. The inventive method allows a large volume of air to be smoothly entrained into the lungs, so that the choking victim can substantially expand their lungs without causing a complete obstruction, and produce an expiratory force or cough powerful enough to dislodge the object causing the obstruction.

Typically a choking person who attempts (or is otherwise encouraged or instructed) to cough will try to cough after inhaling through the mouth. They will also typically lean forward onto something, or otherwise assume a tripod position. As a result, a choking person suffering from a partial airway obstruction routinely will bend over and inhale through their mouth, and will not be able to generate a forceful enough cough to relieve the obstruction. Also, they are at further risk of causing a complete obstruction. The act of sitting or standing up straight and sniffing/inhaling through the nose is advantageous because it provides the ability to create a forceful cough, without risking a complete obstruction.

A first aspect of the invention relates to a method of relieving a partial airway obstruction caused by a foreign object lodged in the upper airway of a human, comprising the steps of (a) sitting or standing erect; (b) inhaling air through the nose; and (c) coughing.

A second aspect of the invention relates to a method for treating a human choking victim with a partial upper airway obstruction caused by a foreign object, comprising the steps of (a) instructing the victim to sit or stand erect; (b) instructing the victim to close their mouth and inhale air through their nose; and (c) instructing the victim to cough, wherein coughing generates an expiratory force sufficient for dislodging the foreign object.

A third aspect of the invention relates to a method of breathing for a choking human to generate a cough for relieving a partial upper airway obstruction caused by a foreign object, the method comprising the steps of (a) sitting or standing erect; (b) closing the mouth; (c) inhaling air through the nose; and (d) coughing with an expiratory force to dislodge the foreign object.

A further understanding of the nature and advantages of the invention will be more fully appreciated with respect to the following drawings and detailed description.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is a midline sagittal view of the oral cavity and pharynx;

FIG. 2 is a posterior view of the oral cavity and pharynx.

### DETAILED DESCRIPTION OF THE INVENTION

As defined herein, the terms “choke” or “choking” mean the inability to breathe due to an obstruction or blockage, either partial or complete, of the trachea. While the term can also be interpreted to include the inability to breathe due to constriction or swelling of the upper airway or trachea, the present invention primarily concerns relief of choking due to acutely occurring partial airway obstructions or blockages of the trachea and upper airways caused by a foreign object, and does not include relief of choking from other means such as infections, allergic reactions, tissue swelling, tracheal strictures or constrictions, tumors, obstructive sleep apnea, emphysema, or other restrictive or obstructive lung diseases.

The terms “foreign object” or “object” relate to a cause of an airway obstruction. Non-limiting examples of commonly encountered foreign objects include any object which comes from outside the body itself such as food, toys, coins and small household objects, as well as mucus or mucus plugs from the lungs.

As defined herein, the term “sniff” means to inhale forcibly through the nose. A typical sniff can last a few seconds, where a “prolonged sniff” means a sniff that lasts from about 5 seconds to about the time it takes for that person to fully inflate their lungs.

The present invention provides a means to quickly alleviate the problem of an acute partial airway obstruction. The invention is based on the observation of many bouts of choking caused by eating too fast (i.e. not chewing food completely). It has been discovered that by encouraging the choking victim to calmly “sit or stand up straight and sniff,” they were able to create a more forceful cough in order to dislodge a foreign object, without causing the foreign object to become further lodged in the airway.

When a human person is choking due to an acute partial airway obstruction, the encouragement by others to cough typically causes the average person to lean forward in a tripod position (i.e. onto something such as the knees, or a table) and cough. The choking victim will then typically inhale through their mouth (or oropharynx), which can cause the object to be moved further down into the airway, potentially leading to a complete airway obstruction. While the tripod position allows the chest (pectoral muscles) to expand the thoracic cavity, this in turns leads to a “head down” position, which encourages mouth breathing and does not allow optimal opening of the posterior pharynx, expansion of the lungs, or movement of the diaphragm. Therefore, forced inhalation through the mouth while in the tripod position prior to coughing typically does not allow a large enough amount of air into the lungs to create a forceful cough.

Forced expiration occurs during coughing, and allows the choking victim to increase peak air flows to dislodge the foreign body. Forced expiration during coughing preferably involves full use of the accessory expiratory muscles. Abdominal muscles and intercostals are accessory expiratory muscles, which can aid the diaphragm in forced expiration and coughing. These accessory muscles are especially helpful when the person is standing erect or sitting up straight. An erect sitting or standing position allows the diaphragm and accessory expiratory muscles to more fully contribute to forced expiration. When the abdominal muscles can fully contract, as in the erect position, it increases intra-abdominal pressure and passively pushes the diaphragm up to empty air from lungs. In a bent over or tripod position the diaphragm is already high in the thorax, and there is not much room to push it higher with forced expiration.

The inventive procedure is intended to teach choking victims to sit or stand erect (i.e. straight up) and breathe in air through the nose and cough, rather than to lean forward or bend over and breathe in through an open mouth. One purpose of this posture is to cause efficient influx of air into the nasopharynx and velopharynx, rather than through the oropharynx, in order to better expand the posterior pharynx and entrain a large volume of air into the lungs. Further, sitting or standing in an erect position will allow gravity to work with the lungs to expand them more than when the person is leaning forward or bending over. This provides greater lung capacity to produce a forceful cough, and also allows the accessory expiratory muscles to come into play and assist the diaphragm to increase forced expiration. In this manner, the victim can generate a cough having an expiratory force sufficient to dislodge a foreign object from the upper airway. Further, performance of the inventive method by breathing or inhaling of air in through the nose is preferably somewhat forceful, as in a sniff or even a prolonged sniff; however, in performing the inventive method, any inhalation through the nose is preferable to mouth inhalation.

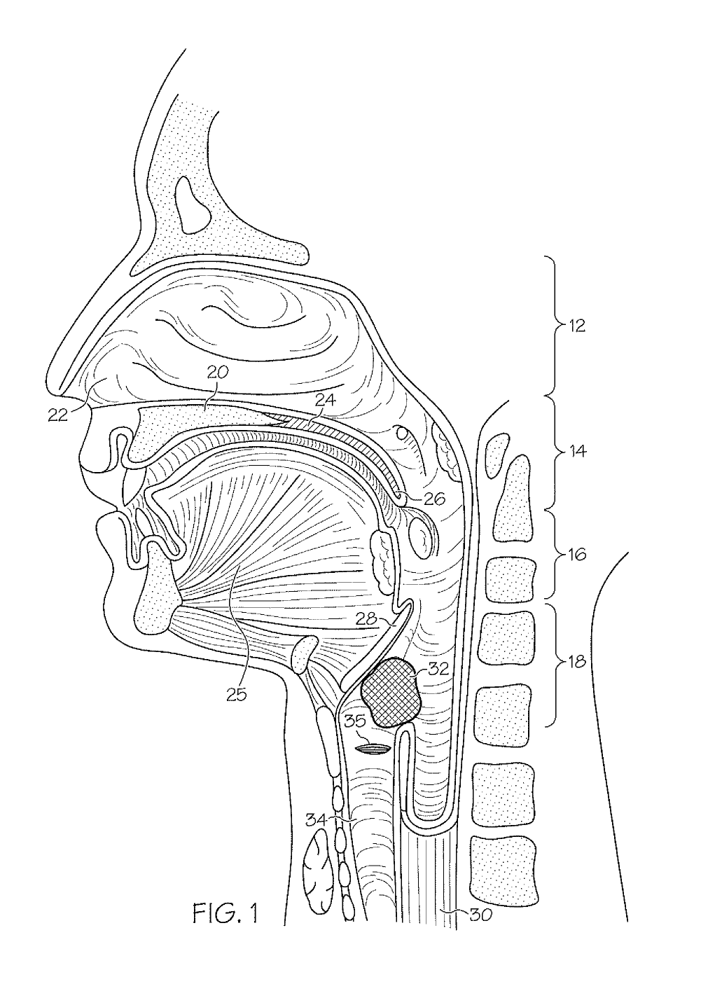

FIG. 1 is a midline sagittal view of the oral cavity and pharynx. From the anatomical standpoint, the airways consist of upper and lower airways. Choking is characterized by obstruction, either complete or partial, of the upper airway or the pharyngeal airway. The pharyngeal airway is divided into four segments, namely the nasopharynx 12, the velopharynx 14, the oropharynx 16, and the hypopharynx 18. The nasopharynx spans from the level of the hard palate 20 to the top of the nasal sinuses/passages 22. The velopharynx 14 spans from the beginning of the soft palate 24 to the end of the soft palate, or uvula 26. The oropharynx includes the tongue 25, and spans from the edge of the soft palate (uvula) 26 to the epiglottis 28. The hypopharynx spans from the epiglottis 28 to the esophagus 30. Also shown is a foreign object 32 lodged within the upper portion of the trachea 34. In this position, the foreign object 32 can be sucked or otherwise drawn down further into the trachea 34 towards (or even beyond) the vocal cords 35, or else expelled out of the trachea and into the mouth or nose by a coughing force.

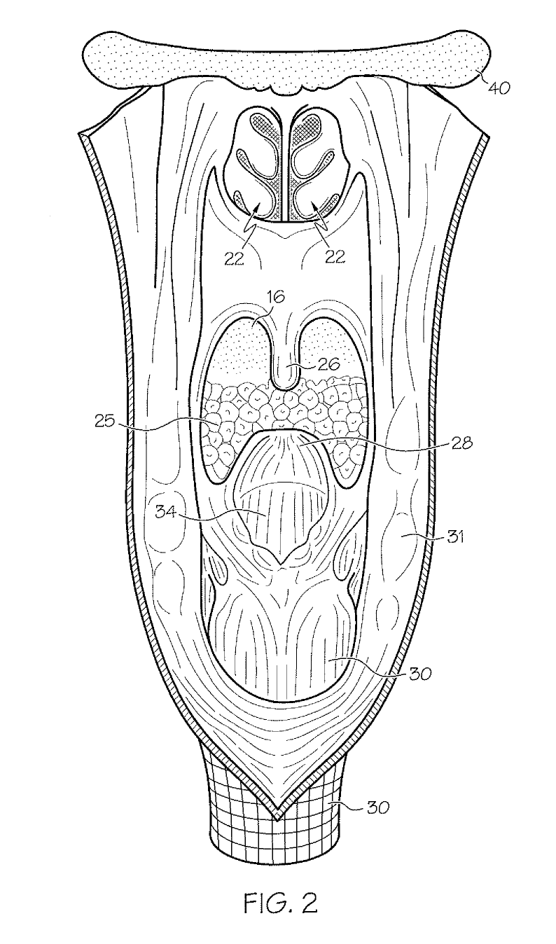

FIG. 2 is a posterior view of the oral cavity and pharynx. In FIG. 2, the spinal column has been removed, so that the view is into the pharynx. The skull base can be seen at item 40. The upper portion of the esophagus 30 and the posterior pharyngeal wall 31 have been opened to show the connections of the nasal sinuses 22 as they lead into the nasopharynx, as well as the soft palate/uvula 26, and the way the epiglottis 28 blocks entry into the tracheal opening 34 from the oropharynx 16.

In general, nose breathing is considered to be superior to mouth breathing even in normal situations where choking is not present, for several reasons. With nose breathing, it can be appreciated from viewing FIGS. 1 and 2 that air travels to and from the external environment and the lungs through the nasal sinuses 22 (as opposed to the oral cavity 16) where it is humidified and filtered. The nasal sinuses 22 also provide mixing of the air with nitric oxide (NO) gas. NO is produced and secreted into the nasal passages 22 and is inhaled through the nose. It is a potent vasodilator, and enhances the uptake of oxygen in the lungs.

In addition, nose breathing imposes approximately 50 percent more resistance to the air stream in normal individuals than does mouth breathing, resulting in 10-20 percent more air uptake. Breathing through the nasal passages 22 causes the air passing through the nasal sinuses to contact the turbinates (shelf-like bony structures, as can be seen in the nasal passages 22 in FIG. 2), which slows down the speed or flow rate of the incoming air. Thus, in a situation where a foreign object is in danger of being sucked further down into the trachea and causing a complete obstruction, inhaling air via the nose, resulting in a lower inspiratory flow rate and pressure, may prevent a complete obstruction caused by vigorous inhalation.

Further, when air enters via the nose 22 instead of the mouth, it is directed through the nasopharynx 12 and into the velopharynx 16, thereby expanding the posterior pharynx. This large amount of humidified air then proceeds smoothly into the lungs and enables the lungs to fully expand. In contrast, mouth breathing causes the air to enter via the oropharynx 16, bypassing the nasopharynx 12 and velopharynx 14. While the (turbulent) air may be able to enter the trachea 34 via the oropharynx 16 faster and more forcefully, typically a smaller amount of air is able to enter the lungs with mouth breathing. As noted above, when the person is sitting or standing erect the lungs can fully expand, such that the diaphragm has more air to work with and can cause the lungs to expel a larger amount of air up the bronchial tubes and towards the trachea. Thus, nose breathing in an upright, erect position allows the choking victim to generate a stronger cough than could be generated through mouth breathing.

The inventive procedure sounds simple, but it is not intuitive. This is especially true in an emergency situation. However, if a choking victim is knowledgeable of and/or instructed to follow the steps of the inventive method, and if the inventive method is done correctly, then they can generate a cough strong enough to forcefully expel the foreign object. Further, the inventive method can be more prone to success if the choking victim can be encouraged or instructed to remain calm. This allows them to relax and allow the slow flow rate of the air entrained through the nasal sinuses to fill the lungs fully, thereby allowing them to generate a strong cough to expel the object. Also, keeping the mouth closed, both prior to and during inspiration through the nose, will direct all of the incoming air through the proper passages (i.e. via the nasopharynx and velopharynx, rather than via the oropharynx), allowing for a more efficient breathing method for the choking victim to entrain enough air to generate a powerful cough to expel the foreign object.

It should be emphasized that it can be advantageous, during such an emergency situation, to keep a choking victim focused on the task at hand, such that it can be useful to instruct the person to continue inhaling through the nose until the lungs “feel full”, i.e. are considered by the choking person to be full, or until the lungs are maximally expanded or at maximum lung capacity. People in such distress generally want to try and generate a cough as fast as possible, and as a result they attempt to cough before enough air is in the lungs, and thus before enough pressure can be generated by the lungs to dislodge the foreign body. But if that person can maintain their calm and patiently continue sniffing/inhaling until the lungs are at maximum lung capacity, without the obstruction being sucked deeper into airway, then they will be at an advantage over a similar choking victim who is agitated, frightened, and hunched over in the tripod position. If the inventive method is used to generate a cough when the victim is comforted or otherwise maintains their calm, and inhales through the nose until they feel like their lungs are full, then it is more likely that the choking victim's cough will generate an expiratory force strong enough to dislodge the foreign object causing the obstruction.

The procedure disclosed herein can be taught to children, or at the earliest age in which there is a level of understanding. In practice, the procedure has been utilized by children beginning at the age of five. Education of the general public by adding this method of breathing for a choking victim to known and currently approved treatment regimens for relieving an airway obstruction in a conscious person can help prevent a complete obstruction, in addition to providing a safe means for relieving a partial airway obstruction.

For example, a simple tag line can be used for education: “When you begin to choke, sit up straight and sniff.” When doing so, air will be directed through the nasopharynx and into the velopharynx, expanding the posterior pharynx, and then down the trachea (at a slower rate than mouth breathing) and into the lungs, which in the erect position are more receptive to filling with air. The individual will also be better able to use the accessory expiratory muscles to generate a cough that is powerful to remove the object that is lodged over part of the trachea or otherwise causing a blockage in the soft tissue in the back of the throat.

While the present invention has been illustrated by the description of embodiments thereof, and while the embodiments have been described in considerable detail, it is not intended to restrict or in any way limit the scope of the appended claims to such detail. Additional advantages and modifications will be readily apparent to those skilled in the art. The invention in its broader aspects is therefore not limited to the specific details, representative system and method, and illustrated examples shown and described. Accordingly, departures may be made from such details without departing from the scope or spirit of the invention.

What is claimed is:

1. A method of relieving a partial airway obstruction caused by a foreign object lodged in the upper airway of a human, comprising the steps of:
a) sitting or standing erect;
b) inhaling air through the nose; and
c) coughing.

2. The method of claim 1, further comprising the step of keeping the mouth closed prior to and during step (b) of inhaling through the nose.

3. The method of claim 1, wherein the step of coughing includes using the accessory expiratory muscles to help the diaphragm generate an expiratory force sufficient to dislodge the foreign object causing the partial obstruction.

4. The method of claim 1, wherein the inhalation step (b) is a prolonged sniff.

5. The method of claim 1, wherein the inhalation step (b) is continued until the lungs are maximally expanded.

6. The method of claim 1, wherein the steps of sitting or standing erect and inhaling air through the nose prevent the occurrence of a complete obstruction.

7. A method for treating a human choking victim with a partial upper airway obstruction caused by a foreign object, comprising the steps of:
a) instructing the victim to sit or stand erect;
b) instructing the victim to close their mouth and inhale air through their nose; and
c) instructing the victim to cough, wherein coughing generates an expiratory force sufficient for dislodging the foreign object.

8. The method of claim 7, further comprising the step of instructing the victim to remain calm.

9. The method of claim 7, wherein in step (b) the victim is further instructed to perform a prolonged sniff.

10. The method of claim 7, wherein in step (b) the victim is further instructed to continue inhaling through the nose until they feel like their lungs are full.

11. A method of breathing for a choking human to generate a cough for relieving a partial upper airway obstruction caused by a foreign object, the method comprising the steps of:
a) sitting or standing erect;
b) closing the mouth;
c) inhaling air through the nose; and
d) coughing with an expiratory force to dislodge the foreign object.

12. The method of claim 11, wherein the inhalation step (c) is a prolonged sniff.

13. The method of claim 11, wherein the inhalation step (c) is continued until the lungs feel full or are maximally expanded.

14. The method of claim 11, wherein the steps (a-c) of sitting or standing erect, closing the mouth and inhaling air through the nose prevent the occurrence of a complete obstruction.

15. The method of claim 11, wherein the step (d) of coughing includes using the accessory expiratory muscles to help the diaphragm generate an expiratory force sufficient to dislodge the foreign object.
